(19) United States
(12) Patent Application Publication
(10) Pub. No.: US 2025/0219130 A1
(43) Pub. Date: Jul. 3, 2025

(54) ALL-SOLID-STATE BATTERY INCLUDING REFERENCE ELECTRODE AND CONTROL METHOD THEREOF

(71) Applicants: Hyundai Motor Company, Seoul (KR); Kia Corporation, Seoul (KR)

(72) Inventors: Young Jin Nam, Seoul (KR); Yong Guk Gwon, Seoul (KR); Yeo Min Yoon, Seoul (KR); Yong Seok Choi, Seoul (KR); Min Sun Kim, Seoul (KR)

(21) Appl. No.: 18/753,454

(22) Filed: Jun. 25, 2024

(30) Foreign Application Priority Data
Dec. 28, 2023 (KR) 10-2023-0194812

(51) Int. Cl. H01M 10/0562; H01M 4/36; H01M 4/76; H01M 10/0525; H01M 10/44; H01M 50/249

(52) U.S. Cl. CPC H01M 10/0562; H01M 4/366; H01M 4/762; H01M 10/0525; H01M 10/441; H01M 50/249

(57) ABSTRACT

Disclosed are an all-solid-state battery including a reference electrode and a control method thereof. The all-solid-state battery includes the reference electrode located between an upper stack including one or more unit cells and a lower stack including one or more unit cells to determine potentials of electrodes in the all-solid-state battery so as to control driving of the all-solid-state battery.

### CROSS-REFERENCE TO RELATED APPLICATION

This application claims under 35 U.S.C. § 119(a) the benefit of Korean Patent Application No. 10-2023-0194812 filed on Dec. 28, 2023, the entire contents of which are incorporated herein by reference.

### BACKGROUND

### Technical Field

The present disclosure relates to an all-solid-state battery including a reference electrode and a control method thereof. More particularly, it relates to an all-solid-state battery including a reference electrode located between an upper stack including one or more unit cells and a lower stack including one or more unit cells to determine potentials of electrodes in the all-solid-state battery so as to control driving of the all-solid-state battery, and a control method of the all-solid-state battery.

### Background

Much research has been conducted on lithium-ion batteries due to their excellent performance, making them widely used in the market. However, lithium-ion batteries have a structural risk of ignition and explosion. Accordingly, research on next-generation batteries with higher energy density and stability than lithium-ion batteries is being actively pursued.

The representative one of these next-generation batteries may be said to be an all-solid-state battery. The all-solid-state battery is a battery in which a solid electrolyte is used. As a result, all materials in the battery are solid.

All-solid-state batteries have excellent stability because they use solid electrolytes which do not pose a risk of evaporation due to temperature changes or leakage due to external shocks. Further, all-solid state batteries may be operated normally even in extreme external environments with high heat and pressure, without experiencing volume expansion (swelling).

In addition, unlike lithium-ion batteries using liquid electrolytes, all-solid-state batteries do not undergo a desolvation reaction, where lithium ions are separated from a solvent during charging and discharging. The charging and discharging reaction is directly connected to the diffusion reaction of lithium ions in the solid, thus being capable of implementing high output.

Further, all-solid-state batteries also have the advantage of having a wide operating temperature. All-solid-state batteries may secure stable performance over a wide temperature range compared to existing liquid electrolytes. Particularly, high ionic conductivity is expected at low temperatures. One of problems of electric vehicles is that battery performance is deteriorated in winter, and thus, a driving range is reduced. When the era of all-solid-state batteries comes, unstable factors in low-temperature environments will be solved.

Performance evaluation related to the above advantages of all-solid-state batteries may be conducted based on various items, such as a charge/discharge capacity, charge/discharge characteristics, high-temperature discharge characteristics, low-temperature discharge characteristics, stability, lifespan, and the like. However, there are still no standardized regulations for performance evaluation.

In relation to this, mid-to long-term electrochemical tests are performed in the process of evaluating durability of all-solid-state batteries, and in order to identify deteriorated factors, it is necessary to separately acquire signals from a cathode and an anode.

In order to separately acquire the signals from the cathode and the anode, a reference electrode may be inserted into a solid electrolyte layer. However, in this case, as charging and discharging are repeated, contamination and deterioration of the reference electrode may worsen due to a chemical reaction on the surface of the reference electrode. In this case, the reference electrode may damage the solid electrolyte layer or increase interfacial resistance, thereby being capable of increasing the possibility of observing characteristics different from performance of an actual all-solid-state battery.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to solve the above-described problems associated with the prior technology, and it is an object of the present disclosure to an all-solid-state battery including a reference electrode, which may separately acquire signals from a cathode and an anode while ensuring performance similar to electrochemical performance of an actual all-solid-state battery, and a control method of the all-solid-state battery.

The objects of the present disclosure are not limited to the above-mentioned objects. The objects of the present disclosure will become clearer from the following description, and may be realized by means stated in the claims and combinations thereof.

In one embodiment, the present disclosure provides an all-solid-state battery including an upper stack including one or more unit cells, a lower stack including one or more unit cells, and a reference electrode unit located between the upper stack and the lower stack, wherein the reference electrode unit includes an upper ion transport layer, a lower ion transport layer, and a reference electrode interposed between the upper ion transport layer and the lower ion transport layer, each of the unit cells in the upper stack and the lower stack includes a solid electrolyte layer, active material layers located on both surfaces of the solid electrolyte layer, and current collectors located on the active material layers, among the unit cells included in the upper stack and the lower stack, each of the current collectors in contact with the reference electrode unit includes a perforated hole formed through its thickness direction thereof, the perforated holes being filled with an active material included in a corresponding active material layer adjacent to the reference electrode unit.

In a preferred embodiment, the upper stack may include two or more unit cells, and the two or more unit cells may be stacked such that polarities of the active material layers located on both surfaces of the current collector are the same.

In another preferred embodiment, the lower stack may include two or more unit cells, and the two or more unit cells may be stacked such that polarities of the active material layers located on both surfaces of the current collector are the same.

In still another preferred embodiment, an area of the upper and lower ion transport layers may be greater than an area of the reference electrode.

In yet another preferred embodiment, a thickness of the reference electrode may be 100 μm or less.

In still yet another preferred embodiment, the all-solid-state battery may include five or more unit cells.

In a further preferred embodiment, the all-solid-state battery may include twenty or more unit cells.

The solid electrolyte may include an oxide-based solid electrolyte or a sulfide-based solid electrolyte.

A diameter of the perforated holes may be 1 mm to 5 mm.

When the corresponding active material layer adjacent to the reference electrode is a cathode active material layer, the perforated hole may be filled with a cathode active material. When the corresponding active material layer adjacent to the reference electrode is an anode active material layer, the perforated hole may be filled with an anode active material.

Also described are a module comprising a plurality of the all-solid-state battery, and a pack comprising a plurality of the module.

In another embodiment, the present disclosure provides a stabilization control method of the all-solid-state battery, including (1) primarily charging and discharging the all-solid-state battery to acquire reference voltage V₀ and end voltage V_{end} of the all-solid-state battery, (2) secondarily charging and discharging the all-solid-state battery under reference voltage conditions to acquire charge voltage V_{cut}, (3) calculating a difference value ΔV (ΔV=| V_{cut}−V₀|) between the charge voltage V_{cut} and the reference voltage V₀, (4) comparing the difference value ΔV with a predetermined control variable α, and deriving a value obtained by subtracting a predetermined correction variable β from the end voltage V_{end} and setting the value as a new end voltage V_{end′}, when the difference value ΔV is greater than or equal to the control variable α, and (5) tertiarily charging and discharging the all-solid-state battery based on the new end voltage V_{end′} set in step (4), wherein the all-solid-state battery is tertiarily charged and discharged under the reference voltage conditions in step (2), when the difference value ΔV is less than the control variable α in step (4).

In a preferred embodiment, the control variable α may be 0.01 or less.

In another preferred embodiment, the correction variable β may be 0.03 to 0.07.

In yet another embodiment, the present disclosure provides a driving control method of two or more all-solid-state batteries as battery cells, including (1) primarily charging and discharging the two or more all-solid-state batteries to acquire reference voltages V_{0,a}, V_{0,b}, . . . and end voltages V_{end,a}, V_{end,b}, . . . of the two or more all-solid-state batteries, (2) secondarily charging and discharging the two or more all-solid-state batteries under respective reference voltage conditions to acquire charge voltages V_{cut,a}, V_{cut,b}, . . . , (3) calculating difference values ΔVₐ, ΔV_{b}, . . . (ΔVₐ=|V_{cut,a}−V_{0,a}|, ΔV_{b}=|V_{cut,b}−V_{0,b}|, . . . ) between the charge voltages V_{cut,a}, V_{cut,b}, . . . and the reference voltages V_{0,a}, V_{0,b}, . . . , (4) comparing the difference values ΔVₐ, ΔV_{b}, . . . with a predetermined control variable α, and deriving values obtained by subtracting a predetermined correction variable β from the end voltages V_{end,a}, V_{end,b}, . . . and setting the values as new end voltages V_{end′,a}, V_{end′,b}, . . . , when the difference values ΔVₐ, ΔV_{b}, . . . are greater than or equal to the control variable α, (5) tertiarily charging and discharging the all-solid-state batteries based on the new end voltages V_{end′,a}, V_{end′,b}, . . . set in step (4), wherein the all-solid-state batteries are tertiarily charged and discharged under the reference voltage conditions in step (2), when the difference values ΔVₐ, ΔV_{b}, . . . are less than the control variable α in step (4).

In a preferred embodiment, the driving control method may include (4) comparing the difference values ΔVₐ, ΔV_{b}, . . . with the predetermined control variable α, and deriving values obtained by collectively subtracting the predetermined correction variable β from the end voltages V_{end,a}, V_{end,b}, . . . and setting the values as new end voltages V_{end′,a}, V_{end′,b}, . . . , when any one of the difference values ΔVₐ, ΔV_{b}, . . . is greater than or equal to the control variable α, and (5) tertiarily charging and discharging the all-solid-state batteries based on the new end voltages V_{end′,a}, V_{end′,b}, . . . set in step (4), and the all-solid-state batteries may be tertiarily charged and discharged under the reference voltage conditions in step (2), when all of the difference values ΔVₐ, ΔV_{b}, . . . are less than the control variable α in step (4).

In another preferred embodiment, the driving control method may include (4) comparing the difference values ΔVₐ, ΔV_{b}, . . . with the predetermined control variable α, and deriving a value obtained by subtracting the predetermined correction variable β from the end voltage of a corresponding one of the all-solid-state batteries having the difference value greater than or equal the control variable α and setting the value as a new end voltage of the corresponding one of the all-solid-state battery, when any one of the difference values ΔVₐ, ΔV_{b}, . . . is greater than or equal to the control variable α, and (5) tertiarily charging and discharging the corresponding one of the all-solid-state batteries based on the new end voltage set in step (4), and others of the all-solid-state batteries determined as having the difference values less than the control variable α in step (4) may be tertiarily charged and discharged under the reference voltage conditions in step (2).

Also disclosed is a vehicle comprising the all-solid-state battery.

Other embodiments and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a cross-sectional view showing an all-solid-state battery according to the present disclosure;

FIG. 2 is a view showing a unit cell according to the present disclosure;

FIG. 3 is a view showing a reference electrode unit according to the present disclosure;

FIG. 4 is a block diagram schematically showing a driving control method of the all-solid-state battery according to the present disclosure;

FIG. 5 is a view showing a battery module or a battery pack including a plurality of all-solid-state batteries according to the present disclosure as battery cells;

FIG. 6 is a graph showing results of primary charging and discharging of an all-solid-state battery according to Example;

FIG. 7 is a graph showing results of secondary charging and discharging of the all-solid-state battery according to Example; and

FIG. 8 is a graph showing evaluation results of capacity retentions of all-solid-state batteries according to various Examples and Comparative Example.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the accompanying drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5,7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A term “all-solid-state battery” as used herein refers to a rechargeable secondary battery that replaces an electrolyte between the anode and the cathode from an existing liquid to a solid.

A term “sheet-type” as used herein refers to a three-dimensional shape of a sheet, film or a thin layer, which has a planar surface and a substantially reduced thickness (e.g., millimeter, micrometer, or nanometer scale) compared to a width or a length of the planar surface.

The term “pouch type battery” as used herein refers to a battery or battery cell designed to seal, surround, wrap or weld each electrode assembly by a pouch-like flexible container (e.g., conductive material, metal, or polymer pouch), and each of the pouch-like container carries or accommodates essential battery cell components or electrode assembly, such as an electrode (e.g., a cathode and anode), a separator disposed between the electrodes, electrolyte, a gas diffusion layer, and the like. The each of the pouch-like container may further include a connecting part, e.g., for connection between, or a portion for exchanging materials inside thereof with others, which can be stacked or packed in either horizontal or vertical directions.

### All-Solid-State Battery

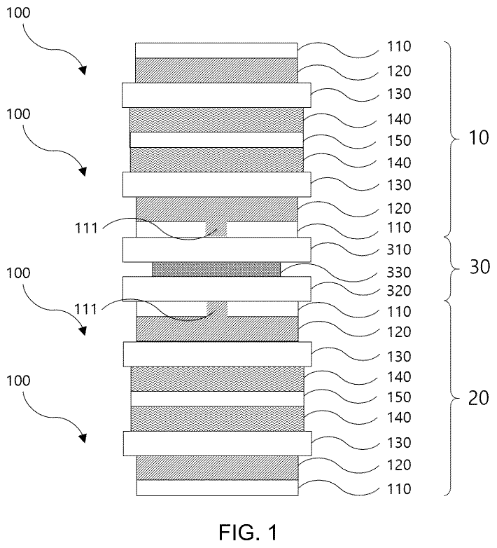

FIG. 1 is a cross-sectional view showing an all-solid-state battery according to the present disclosure. The all-solid-state battery shown in FIG. 1 may include an upper stack 10 including one or more unit cells 100, a lower stack 20 including one or more unit cells 100, and a reference electrode unit 30 located between the upper stack 10 and the lower stack 20.

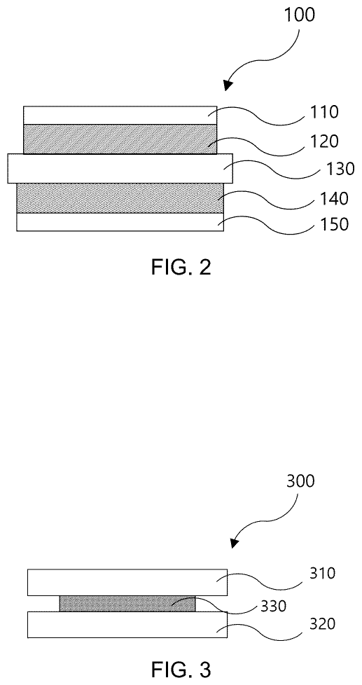

FIG. 2 shows one unit cell 100 according to the present disclosure. The unit cell 100 shown in FIG. 2 may include a solid electrolyte layer 130, active material layers 120 and 140 located on both surfaces of the solid electrolyte layer 130, and current collectors 110 and 150 located on the active material layers 120 and 140.

The solid electrolyte layer 130 may include a solid electrolyte having lithium-ion conductivity. Specifically, the solid electrolyte may include an oxide-based solid electrolyte or a sulfide-based solid electrolyte. A sulfide-based solid electrolyte having high lithium-ion conductivity may preferably be used. The sulfide-based solid electrolyte may include Li2S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like, without being particularly limited. The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

Each of the active material layers 120 and 140 located on both surfaces of the solid electrolyte layer 130 may be an anode active material layer including an anode active material, or a cathode active material layer including a cathode active layer. Here, the active material layer 120 located on one surface of the solid electrolyte layer 130 and the active material layer 140 located on the other surface of the solid electrolyte layer 130 may be different. For example, when the active material layer 120 located on one surface of the solid electrolyte layer 130 is an anode active material layer, the active material layer 140 located on the other surface of the solid electrolyte layer 130 may be a cathode active material layer. Otherwise, when the active material layer 120 located on one surface of the solid electrolyte layer 130 is a cathode active material layer, the active material layer 140 located on the other surface of the solid electrolyte layer 130 may be an anode active material layer.

A compound capable of reversibly intercalating and deintercalating lithium may be used as the anode active material. For example, the anode active material may include a carbonaceous material, such as artificial graphite, natural graphite, graphitized carbon fiber, or amorphous carbon, a metallic compound that is alloyable with lithium, such as Si, Al, Sn, Pb, Zn, Bi, In, Mg, Ga, Cd, an Si alloy, an Sn alloy, or an Al alloy, a metal oxide that is capable of doping or dedoping lithium, such as SiO_{β} (0<β<2), SnO₂, vanadium oxide, lithium vanadium oxide, or a composite including the metallic compound and the carbonaceous material, such as a Si—C composite or a Sn—C composite, and any one thereof or a mixture of two or more thereof may be used. Further, metallic lithium thin film may be used as the anode active material.

The cathode active material layer may include a cathode active material, a solid electrolyte, a conductive material, a binder, and the like. The cathode active material may intercalate and deintercalate lithium ions, and may include a rocksalt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rocksalt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), lithium titanate, such as Li₄Ti₅O₁₂, or the like.

The conductive material may include carbon black, conductive graphite, acetylene black, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

Materials which may be used as the solid electrolyte included in the cathode active material layer are substantially the same as those included in the solid electrolyte layer 130, and a detailed description thereof will thus be omitted. In addition, a material which is the same as or different from a material used as the solid electrolyte included in the solid electrolyte layer 130 may be used as the solid electrolyte included in the cathode active material layer.

Each of the current collectors 110 and 150 may be a cathode current collector or an anode current collector. When the active material layer in contact with the current collector 110 or 150 is a cathode active material layer, the current collector 110 or 150 may be a cathode current collector. Further, when the active material layer in contact with the current collector 110 or 150 is an anode active material layer, the current collector 110 or 150 may be an anode current collector.

The cathode current collector serves as a conduit for transferring electrons from the outside to facilitate an electrochemical reaction in the cathode active material in the battery. It also receives electrons from the cathode active material and to send the received electrons to the outside.

The cathode current collector may include a plate-type substrate having electrical conductivity. For example, the cathode current collector may include aluminum foil. Here, the thickness of the cathode current collector is not particularly limited, and may be, for example, 1 μm to 500 μm.

The anode current collector may include a plate-type substrate having electrical conductivity. For example, the anode current collector may include a material which does not react with lithium. Concretely, the anode current collector may include at least one selected from the group consisting of nickel (Ni), copper (Cu), stainless steel (SUS), and combinations thereof. The thickness of the anode current collector is not particularly limited, and may be, for example, 1 μm to 500 μm.

FIG. 3 shows the reference electrode unit 30 according to the present disclosure. For example, the reference electrode unit 30 shown in FIG. 3 may include an upper ion transport layer 310, a lower ion transport layer 320, and a reference electrode 330 interposed between the upper ion transport layer 310 and the lower ion transport layer 320. Here, the “reference electrode” may be defined as an electrode having a stable electrochemical potential which serves as a reference point for measuring the potential of at least one electrode in an electrochemical cell.

In one embodiment, the reference electrode 330 may be of a sheet type. By using the sheet-type reference electrode 330, which has a thin thickness and an area similar to that of the active material layers, durability evaluation of the all-solid-state battery may become possible. For example, the reference electrode 330 may be lithium foil.

Further, the thickness of the reference electrode 330 may be 100 μm or less. When the thickness of the reference electrode 330 exceeds 100 μm, the energy density of the all-solid-state battery may be reduced, and the all-solid-state battery may exhibit electrochemical characteristics different from those of an all-solid-state battery not including the reference electrode 330. The lower limit of the thickness of the reference electrode 330 is not particularly limited, and may be, for example, 10 μm or more.

Further, the area of the ion transport layers 310 and 320 may be greater than the area of the reference electrode 330. As the area of the ion transport layers 310 and 320 are greater than the area of the reference electrode 330, internal short circuit between the reference electrode 330 and the active material layers 120 and 140 may be prevented.

Further, the area of the ion transport layers 310 and 320 may be greater than the area of the active material layers 120 and 140 to prevent pressure applied during the assembly process of the all-solid-state battery from being concentrated.

The upper ion transport layer 310 and the lower ion transport layer 320 may include a solid electrolyte having lithium-ion conductivity. Materials which may be used as the solid electrolyte included in the ion transport layers 310 and 320 are substantially the same as the materials which may be used as the solid electrolyte included in the solid electrolyte layer 130, and a detailed description thereof will thus be omitted. In addition, the solid electrolyte used in the ion transport layers 310 and 320 can be the same as or different from the material used in the solid electrolyte layer 130.

In one embodiment, the all-solid-state battery in which, among the unit cells 100 included in the upper stack 10 and the lower stack 30, each of the current collectors 110 in contact with the reference electrode unit 30 may include a perforated hole 111 formed through the corresponding current collector 110 in the thickness direction thereof, and the perforated holes 111 of the current collectors 110 are filled with the active material included in the active material layer 120.

Here, when the active material layers 120 adjacent to the reference electrode unit 30 are cathode active material layers, the active material filling the perforated holes 111 may be a cathode active material. Alternatively, when the active material layers 120 adjacent to the reference electrode unit 30 are anode active material layers, the active material filling the perforated holes 111 may be an anode active material.

In this way, as the perforated holes 111 are formed in the current collectors 110 in contact with the reference electrode unit 30 and are filled with the active material, lithium ion passages may be formed between the unit cells 100 adjacent to the reference electrode unit 30 and the reference electrode unit 30 during the charging and discharging process of the all-solid-state battery.

In addition, filling the perforated holes 111 with the active material is to secure lithium ion transfer paths between the reference electrode unit 30 and the adjacent active material layers 120. Therefore, in addition to the active material, the perforated holes 111 may be filled with a solid electrolyte having high lithium-ion conductivity.

In one embodiment, the diameter of the perforated holes 111 may be 1 mm to 5 mm. When the diameter of the perforated holes 111 exceeds 5 mm, conduction of electrons through the current collectors 110 may be reduced and thus performance of the all-solid-state battery may be deteriorated.

In one embodiment, the upper stack 10 may include two or more unit cells 100, and the two or more unit cells 100 may be stacked such that polarities of the active material layers 140 located on both surfaces of the current collector 50 are the same. Here, the two or more unit cells 100 may be provided such that with one unit cell 100 included in the upper stack 10 and the other unit cell 100 in contact with the unit cell 100 share the current collector 150, as shown in FIG. 1.

In one embodiment, the lower stack 20 may include two or more unit cells 100, and the two or more unit cells 100 may be stacked such that polarities of the active material layers 140 located on both surfaces of the current collector 50 are the same. Here, the two or more unit cells 100 may be provided such that with one unit cell 100 is included in the upper stack 10, and the other unit cell 100, which is in contact with the unit cell 100, shares the current collector 150, as shown in FIG. 1.

In one embodiment, as the adjacent unit cells 100 share the current collector 150, the overall volume of the all-solid-state battery may be reduced and the energy density of the all-solid-state battery may be improved.

Although FIG. 1 shows two unit cells 100 stacked in each of the upper stack 10 and the lower stack 20, the structure of the all-solid-state battery may be appropriately adjusted to accommodate an increased number of stacked unit cells. In one embodiment, the all-solid-state battery may include five or more unit cells 100. Further, the all-solid-state battery may include twenty or more unit cells 100.

### Driving Control Method of All-Solid-State Battery

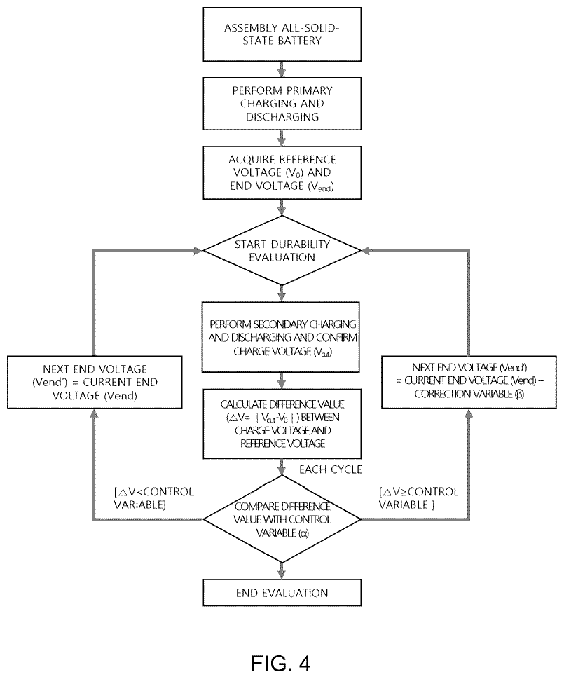

FIG. 4 is a block diagram schematically showing a driving control method of the all-solid-state battery according to the present disclosure. The driving control method shown in FIG. 4 may include (1) primarily charging and discharging the all-solid-state battery to acquire reference voltage V₀ and end voltage V_{end} of the all-solid-state battery, (2) secondarily charging and discharging the all-solid-state battery under reference voltage conditions to acquire charge voltage V_{cut}, (3) calculating a difference value ΔV (ΔV=|V_{cut}−V₀|) between the charge voltage V_{cut} and the reference voltage V₀, (4) comparing the difference value ΔV with predetermined control variable α, and deriving a value obtained by subtracting a predetermined correction variable β from the end voltage V_{end} and setting the value as a new end voltage V_{end′}, when the difference value ΔV is greater than or equal to the control variable α, and (5) tertiarily charging and discharging the all-solid-state battery based on the new end voltage V_{end′} set in step (4). The driving control method may further include tertiarily charging and discharging the all-solid-state battery under the reference voltage conditions in step (2), when the difference value ΔV is less than the control variable α in step (4).

Hereinafter, the respective steps will be described in more detail. First, the all-solid-state battery including the upper stack 10, the lower stack 20, and the reference electrode unit 30 interposed therebetween may be assembled.

Thereafter, the all-solid-state battery may be primarily charged and discharged as in step (1) above. Here, the primary charging and discharging of the all-solid-state battery refers to the initial charging and discharging, which may involve a formation process that activates the all-solid-state battery and imparts electrical characteristics to it.

Results of the primary charging and discharging of the all-solid-state battery may be shown in a capacity (mAh/g) versus voltage (V) graph, total voltage of the all-solid-state battery which has reached cut-off voltage may be set as the end voltage V_{end}, and individual electrode voltage measured on an electrode active material layer adjacent to the reference electrode unit 30, which secures a lithium ion transfer path, using the reference electrode 330 may be set as the reference voltage V₀. Here, the reference voltage V₀ may be cathode voltage or anode voltage depending on whether the active material layer adjacent to the reference electrode unit 30 is a cathode active material layer or an anode active material layer.

After primarily charging and discharging the all-solid-state battery, the all-solid-state battery is secondarily charged and discharged under the reference voltage conditions. The “reference voltage conditions” under which the all-solid-state battery is secondarily charged and discharged may include the reference voltage V₀ and the end voltage V_{end} acquired in primarily charging and discharging the all-solid-state battery.

Thereafter, the all-solid-state battery is secondarily charged and discharged as in step (2) above. The all-solid-state battery is secondarily charged and discharged until the total voltage of the all-solid-state battery reaches the end voltage V_{end} acquired in primarily charging and discharging the all-solid-state battery. Results of the secondary charging and discharging of the all-solid-state battery may be shown in a capacity (mAh/g) versus voltage (V) graph, and individual electrode voltage measured using the reference electrode 330 may be set as the charge voltage V_{cut}.

According to the present disclosure, electrodes adjacent to the reference electrode unit 30 may be located in the upper stack 10 and the lower stack 20, respectively. When a plurality of active material layer voltages is to be measured using the reference electrode 330, charge voltages which are individual electrode voltages may be expressed as V_{cut1}, V_{cut2}, . . . . At this time, the measured voltages V_{cut1}, V_{cut2}, . . . may be different due to reasons, such as poor quality of electrodes or combination with counter electrodes. Here, the charge voltage V_{cut} used below may refer to voltage having a relatively high potential among the plurality of charge voltages V_{cut1}, V_{cut2}, . . . .

In step (3), the difference value ΔV (ΔV=|V_{cut}−V₀|) between the charge voltage V_{cut} derived in secondarily charging and discharging the all-solid-state battery and the reference voltage V₀ derived in primarily charging and discharging the all-solid-state battery may be calculated.

Thereafter, in step (4), the difference value ΔV may be compared with the predetermined control variable. Here, the control variable α may be less than 0.02.Preferably, the control variable α may be less than 0.01. When the control variable α exceeds 0.01, the all-solid-state battery may be easily overcharged and thus the lifespan characteristics thereof may be deteriorated.

When the difference value ΔV is greater than or equal to the control variable α, the value obtained by subtracting the predetermined correction variable β from the end voltage V_{end} may be derived, and this value may be set as the new end voltage V_{end′}. Here, the correction variable β may be 0.03 to 0.07. When the correction variable β is less than 0.03, a difference between the end voltage V_{end} used in the current charge and discharge cycle and the end voltage V_{end′} used in the next charge and discharge cycle is too small, and thus it is difficult to properly respond to the deterioration rate of the all-solid-state battery. When the correction variable β exceeds 0.07, the difference between the end voltage V_{end} used in the current charge and discharge cycle and the end voltage V_{end′} used in the next charge and discharge cycle becomes too large, which may accelerate the deterioration of the all-solid-state battery.

On the other hand, when the difference value ΔV is less than the control variable α, the end voltage V_{end} may be set as the new end voltage V_{end′}, and then, the all-solid-state battery may be tertiarily charged and discharged.

It has been described that the all-solid-state battery is tertiarily charged and discharged by setting the new end voltage, as described above, in the driving control method of the all-solid-state battery according to the present disclosure, but even when more charging and discharging cycles are performed to evaluate durability of the all-solid-state battery, end voltages V_{end′}, V_{end}″, V_{end′″}, . . . may be adjusted through the same process.

For example, after primarily charging and discharging the all-solid-state battery, charging and discharging of the all-solid-state battery may be performed up to an n^{th} charge and discharge cycle (n=2, 3, 4, . . . ) under the reference voltage conditions. The “reference voltage conditions” may include the reference voltage V₀ acquired by primarily charging and discharging the all-solid-state battery and the end voltage V_{end, n-1} acquired by performing (n−1)^{th} charging and discharging of the all-solid-state battery.

Thereafter, n^{th} charging and discharging of the all-solid-state battery may be performed as in step (2). The n^{th} charging and discharging of the all-solid-state battery may be performed until the total voltage of the all-solid-state battery reaches the end voltage V_{end, n-1} acquired by the (n−1)^{th} charging and discharging of the all-solid-state battery. Results of the n^{th} charging and discharging of the all-solid-state battery may be shown in a capacity (mAh/g) versus voltage (V) graph, and individual electrode voltage measured using the reference electrode 330 may be set as the charge voltage V_{cut, n}.

In step (3), a difference value ΔV (ΔV=|V_{cut,n}−V₀|) between the charge voltage V_{cut} derived from the n^{th} charging and discharging of the all-solid-state battery and the reference voltage V₀ derived from the primary charging and discharging of the all-solid-state battery may be calculated.

Thereafter, in step (4), the difference value ΔV may be compared with the predetermined control variable α.

When the difference value ΔV is greater than or equal to the control variable α, a value obtained by subtracting the predetermined correction variable β from the end voltage V_{end,n-1} may be derived, and this value may be set as a new end voltage V_{end′,n}.

### Driving Control Method of a Plurality of Battery Cells

In general, batteries may be composed of units called cells, modules, and packs. At least two cells may be combined to form one module, and at least two modules are combined to form a pack. When a battery pack is mounted and used in a product, the degree of deterioration of individual cells may vary depending on the qualities of the individual cells, the driving logic of the battery, and other factors.

According to the present disclosure, driving of a battery module including a plurality of battery cells with different degrees of deterioration may be collectively controlled or individually controlled. The “battery cell” is substantially the same as the above-described all-solid-state battery including the upper stack including one or more unit cells, the lower stack including one or more unit cells, and the reference electrode unit located therebetween, and a detailed description thereof will thus be omitted.

“Collective control” may mean collectively lowering the end voltages V_{end} of a plurality of battery cells included in the battery module by the correction variable β. That is, collective control may mean a voltage control method based on the battery module.

Further, “individual control” may mean individually controlling the respective end voltages V_{end} of the plurality of battery cells included in the battery module or the battery pack. This reflects the recent trend of battery systems in which are developed toward the form of C2P (cell-to-pack) while omitting module units.

Specifically, the reference electrode unit may be installed in each of the plurality of battery cells, and steps (1) to (5) may be performed according to the “driving control method of all-solid-state battery”. In case of only a battery cell having a difference value ΔV which is greater than or equal to the control variable α, among the plurality of battery cells, a value obtained by subtracting the correction variable β from the end voltage V_{end} of the corresponding battery cell may be set as a new end voltage V_{end′}.

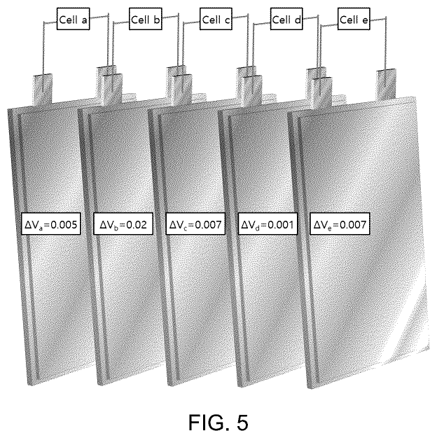

FIG. 5 shows five battery cells (cell a, cell b, cell c, cell d, and cell e) to explain a method of collectively controlling or individually controlling the end voltages of the battery cells included in a battery module or a battery pack. Although the battery module is shown as including the five battery cells (cell a, cell b, cell c, cell d, and cell e), the number of the battery cells may vary.

An example of the method of collectively controlling the end voltages of the battery cells is as follows.

(1) The all-solid-state battery may be primarily charged and discharged under predetermined charge and discharge conditions to acquire reference voltages V_{0,a}, V_{0,b}, V_{0,c}, V_{0,d}, and V_{0,e}, and end voltages V_{end,a}, V_{end,b}, V_{end,c}, V_{end,d}, and V_{end,e} of the respective battery cells.

(2) The all-solid-state battery may be secondarily charged and discharged under reference voltage conditions of the respective battery cells to acquire charge voltages V_{cut,a}, V_{cut,b}, V_{cut,c}, V_{cut,d}, and V_{cut,e} of the respective battery cells.

(3) Difference values ΔVₐ, ΔV_{b}, ΔV_{c}, ΔV_{d}, and ΔVₑ (ΔVₐ=|V_{cut,a}−V_{0,a}|=0.005, ΔV_{b}=|V_{cut,b}−V_{0,b}|=0.02, ΔV_{c}=|V_{cut,c}−V_{0,c}|=0.007, ΔVₐ=|V_{cut,d}−V_{0,d}|=0.001, and ΔVₑ=|V_{cut,e}−V_{0,e}|=0.007) between the charge voltages V_{cut,a}, V_{cut,b}, V_{cut,c}, V_{cut,d}, and V_{cut,e} and reference voltages V_{0,a}, V_{0,b}, V_{0,c}, V_{0,d}, and V_{0,e}, may be calculated.

(4) The difference values ΔVₐ, ΔV_{b}, ΔV_{c}, ΔV_{d}, and ΔVₑ may be compared with a predetermined control variable α (α=0.01), values obtained by collectively subtracting a predetermined correction variable β (β=0.02) from the end voltages V_{end,a}, V_{end,b}, V_{end,c}, V_{end,d}, and V_{end,e} may be derived, when any one ΔV_{b} (ΔV_{b}=0.02) of the difference values ΔVₐ, ΔV_{b}, ΔV_{c}, ΔV_{d}, and ΔVₑ is greater than or equal to the control variable α, and these values may be set to new end voltages V_{end′,a}, V_{end′,b}, V_{end′,c}, V_{end′,d}, and V_{end′,e} (V_{end′,a}=V_{end,a}−0.02, V_{end′,b}=V_{end,b}−0.02, V_{end′,c}=V_{end,c}−0.02, V_{end′,d}=V_{end,d}−0.02, and V_{end′,e}=V_{end,e}−0.02).

An example of the method of individually controlling the end voltages of the battery cells is as follows.

First, steps (1) to (3) of the method of collectively controlling the end voltages of the battery cells are performed in the same manner.

After calculating charge voltages V_{cut,a}, V_{cut,b}, V_{cut,c}, V_{cut,d}, and V_{cut,e} and reference voltages V_{0,a}, V_{0,b}, V_{0,c}, V_{0,d}, and V_{0,e} of the respective battery cells and difference values ΔVₐ, ΔV_{b}, ΔV_{c}, ΔV_{d}, and ΔVₑ therebetween through steps (1) to (3), (4) the difference values ΔVₐ, ΔV_{b}, ΔV_{c}, ΔV_{d}, and ΔVₑ may be compared with a predetermined control variable α (α=0.01), a value obtained by subtracting a predetermined correction variable β (β=0.02) from the end voltage V_{end,b} of a corresponding one (cell b) of the battery cells having the difference value ΔV_{b} greater than or equal to the control variable α may be derived, when any one ΔV_{b} (ΔV_{b}=0.02) of the difference values ΔVₐ, ΔV_{b}, ΔV_{c}, ΔV_{d}, and ΔVₑ is greater than or equal to the control variable α, and the value may be set to a new end voltage V_{end′,b} of the corresponding battery cell. On the other hand, the end voltages V_{end,a}, V_{end,c}, V_{end,d}, and V_{end,e} of other battery cells may be set to new end voltages V_{end′,a}, V_{end′,c}, V_{end′,d}, and V_{end′,e} of the battery cells. (V_{end′,a}=V_{end,a}, V_{end′,b}=V_{end,b}−0.02, V_{end′,c}=V_{end,c}, V_{end′,d}=V_{end,d}, and V_{end′,e}=V_{end,e}).

According to the present disclosure, the efficiency of a battery management system may be improved through not only collective control on a module basis but also individual control on a battery cell basis.

Hereinafter, the present disclosure will be described in more detail through the following Examples and Comparative Examples. The following Examples and Comparative Examples serve merely to exemplarily describe the present disclosure, and are not intended to limit the scope and spirit of the disclosure.

### EXAMPLE

In order to evaluate durability of an all-solid-state battery, a pouch-type all-solid-state battery having the same structure as in FIG. 1 but having four unit cells 10 stacked in each of an upper stack and a lower stack was manufactured. Lithium metal foil was used as a reference electrode. Current collectors and active material layers adjacent to a reference electrode unit were set as cathode current collectors and cathode active material layers, respectively.

In addition, the area of an anode including an anode current collector and an anode active material layer was set to be slightly larger than the area of a cathode including the cathode current collector and the cathode active material layer. The areas of ion transport layers and solid electrolyte layers were set to be large than the areas of the reference electrode, the cathodes and the anodes.

The all-solid-state battery including the upper stack, the lower stack and the reference electrode unit was vacuum-sealed with a pouch, and then, ultra-high pressure was applied thereto though the warm isostatic press (WIP) process. At this time, the thickness of the reference electrode unit was measured to be 50 μm.

### Comparative Example

An all-solid-state battery was constructed to have the same structure as in FIG. 1, but to have only an upper stack and a lower stack, each of which includes four unit cells 100 stacked, without a reference electrode unit. Here, the unit cells 100 located at the contact portion between the upper stack and the lower stack were set to share a cathode current collector. The all-solid-state battery was manufactured so that other elements thereof are the same as in the above Example.

### Test Example

(1) After primarily charging and discharging the all-solid-state batteries according to

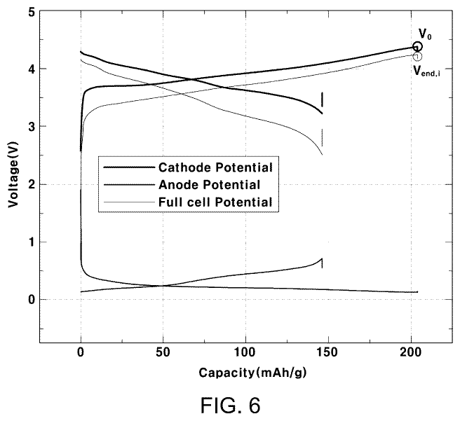

Example and Comparative Example, potentials of the anodes, the cathodes, and the entire cells of the all-solid-state batteries were measured. Results of measurement are shown in FIG. 6.

[Full cell potential=cathode potential−anode potential]

Here, the cut-off voltage in primary charging and discharging was set to 4.25 V, and the cut-off voltage was indicated as end voltage V_{end} in FIG. 6. Further, cathode potential determined from primary charging and discharging was set as reference voltage V₀.

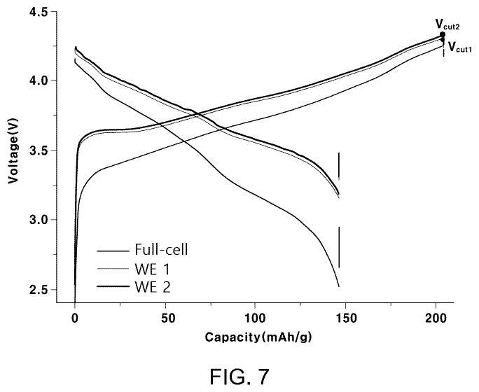

(2) Thereafter, the all-solid-state batteries were secondarily charged and discharged under the above reference voltage conditions (V₀, V_{end}). Results of this are shown in FIG. 7. In FIG. 7, charge voltage between the reference electrode unit and the cathode active material layer located in the upper stack is indicated as V_{cut1}, and charge voltage between the reference electrode unit and the cathode active material layer located in the lower stack is indicated as V_{cut2}.

(3) Among the charge voltages V_{cut1} and V_{cut2} of the all-solid-state battery shown in FIG. 7, V_{cut2} which was relatively higher voltage was set as the charge voltage V_{cut}, and a difference value ΔV (ΔV=|V_{cut}−V₀|) between the charge voltage V_{cut} and the reference voltage V₀ was calculated.

(4) After comparing the difference value ΔV with a control variable α, when the difference value ΔV is greater than or equal to the control variable α a value obtained by subtracting a correction variable β of 0.05 from the end voltage V_{end} was derived, and the value was set as end voltage V_{end′} during subsequent charging and discharging of the all-solid-state battery. Further, when the difference value ΔV is less than the control variable α, the end voltage V_{end} was set as the end voltage V_{end′} during subsequent charging and discharging of the all-solid-state battery. Here, the control variable α was set to 0.001, 0.005, 0.01 and 0.02.

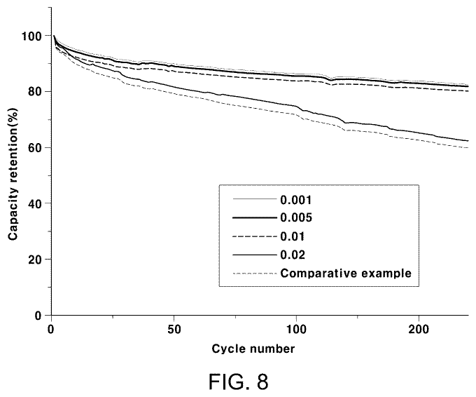

The lifespan characteristics of the all-solid-state batteries according to Example and Comparative Example were evaluated by changing the end voltage in the charge/discharge cycle using the above-described method. Results of evaluation are shown in FIG. 8.

Referring to FIG. 8, it was confirmed that the smaller the value of the control variable a, the better the capacity retention of the all-solid-state battery. Particularly, when the control variable α was set to 0.02, the capacity retentions of the all-solid-state batteries were rapidly reduced. Further, the capacity retention of the all-solid-state battery according to Comparative Example to which the control method according to the present disclosure may not be applied because it does not include a reference electrode unit was confirmed to be the lowest.

As is apparent from the above description, an all-solid-state battery according to the present disclosure includes a reference electrode located between an upper stack and a lower stack. This design allows separate acquisition of signals from a cathode and an anode while ensuring performance similar to electrochemical performance of an actual all-solid-state battery.

Further, a difference value between reference voltage acquired by primarily charging and discharging the all-solid-state battery according to the present disclosure and charge voltage acquired by secondarily charging and discharging the all-solid-state battery is compared with a control variable, and a value obtained by subtracting a correction variable from end reference voltage is set to new end voltage when the difference value is greater than or equal to the control variable, thereby being capable of minimizing deterioration of the all-solid-state battery and improving lifespan characteristics of the all-solid-state battery.

In addition, when a plurality of all-solid-state batteries according to the present disclosure is included as battery cells, not only collective control but also individual control of driving of the respective battery cells is possible, thereby improving overall battery driving efficiency.

The effects of the present disclosure are not limited to the above-mentioned effects. The effects of the present disclosure should be understood to include all effects that may be inferred from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. An all-solid-state battery comprising:
an upper stack comprising one or more unit cells;
a lower stack comprising one or more unit cells; and
a reference electrode unit located between the upper stack and the lower stack,
wherein the reference electrode unit comprises an upper ion transport layer, a lower ion transport layer, and a reference electrode interposed between the upper ion transport layer and the lower ion transport layer,
wherein each of the unit cells in the upper stack and the lower stack comprises a solid electrolyte layer, active material layers located on both surfaces of the solid electrolyte layer, and current collectors located on the active material layers,
wherein among the unit cells in the upper stack and the lower stack, each of the current collectors in contact with the reference electrode unit comprises a perforated hole formed through its thickness direction thereof, the perforated hole being filled with an active material in a corresponding active material layer adjacent to the reference electrode unit.

2. The all-solid-state battery of claim 1, wherein:
the upper stack comprises two or more unit cells, and
the two or more unit cells are stacked such that polarities of the active material layers located on both surfaces of the current collector are the same.

3. The all-solid-state battery of claim 1, wherein:
the lower stack comprises two or more unit cells, and
the two or more unit cells are stacked such that polarities of the active material layers located on both surfaces of the current collector are the same.

4. The all-solid-state battery of claim 1, wherein an area of the upper and lower ion transport layers is greater than an area of the reference electrode.

5. The all-solid-state battery of claim 1, wherein a thickness of the reference electrode is 100 μm or less.

6. The all-solid-state battery of claim 1, comprising five or more unit cells.

7. The all-solid-state battery of claim 1, comprising twenty or more unit cells.

8. The all-solid-state battery of claim 1, wherein the solid electrolyte comprises an oxide-based solid electrolyte or a sulfide-based solid electrolyte.

9. The all-solid-state battery of claim 1, wherein a diameter of the perforated holes is 1 mm to 5 mm.

10. The all-solid-state battery of claim 1, wherein when the corresponding active material layer adjacent to the reference electrode is a cathode active material layer, the perforated hole is filled with a cathode active material.

11. The all-solid-state battery of claim 1, wherein when the corresponding active material layer adjacent to the reference electrode is an anode active material layer, the perforated hole is filled with an anode active material.

12. A module comprising a plurality of the all-solid-state battery of claim 1.

13. A pack comprising a plurality of the module of claim 12.

14. A stabilization control method of the all-solid-state battery according to claim 1, the stabilization control method comprising:
(1) primarily charging and discharging the all-solid-state battery to acquire reference voltage V₀ and end voltage V_{end} of the all-solid-state battery;
(2) secondarily charging and discharging the all-solid-state battery under reference voltage conditions to acquire charge voltage V_{cut};
(3) calculating a difference value ΔV (ΔV=|V_{cut}−V₀|) between the charge voltage V_{cut} and the reference voltage V₀;
(4) comparing the difference value ΔV with a predetermined control variable α, and deriving a value obtained by subtracting a predetermined correction variable β from the end voltage V_{end} and setting the value as a new end voltage V_{end′}, if the difference value ΔV is greater than or equal to the control variable α; and
(5) tertiarily charging and discharging the all-solid-state battery based on the new end voltage V_{end′} set in the step (4),
wherein the all-solid-state battery is tertiarily charged and discharged under the reference voltage conditions in the step (2), when the difference value ΔV is less than the control variable α in the step (4).

15. The stabilization control method of claim 14, wherein the control variable α is 0.01 or less.

16. The stabilization control method of claim 14, wherein the correction variable β is 0.03 to 0.07.

17. A driving control method of two or more all-solid-state batteries according to claim 1 as battery cells, comprising:
(1) primarily charging and discharging the two or more all-solid-state batteries to acquire reference voltages V_{0,a}, V_{0,b}, . . . and end voltages V_{end,a}, V_{end,b}, . . . of the two or more all-solid-state batteries;
(2) secondarily charging and discharging the two or more all-solid-state batteries under respective reference voltage conditions to acquire charge voltages V_{cut,a}, V_{cut,b}, . . . ;
(3) calculating difference values ΔVₐ, ΔV_{b}, . . . (ΔVₐ=|V_{cut,a}−V_{0,a}|, ΔV_{b}=|V_{cut,b}−V_{0,b}|, . . . ) between the charge voltages V_{cut,a}, V_{cut,b}, . . . and the reference voltages V_{0,a}, V_{0,b}, . . . ;
(4) comparing the difference values ΔVₐ, ΔV_{b}, . . . with a predetermined control variable α, and deriving values obtained by subtracting a predetermined correction variable β from the end voltages V_{end,a}, V_{end,b}, . . . and setting the values as new end voltages V_{end′,a}, V_{end′,b}, . . . , when the difference values ΔVₐ, ΔV_{b}, . . . are greater than or equal to the control variable α; and
(5) tertiarily charging and discharging the all-solid-state batteries based on the new end voltages V_{end′,a}, V_{end′,b}, . . . set in the step (4),
wherein the all-solid-state batteries are tertiarily charged and discharged under the reference voltage conditions in the step (2), when the difference values ΔVₐ, ΔV_{b}, . . . are less than the control variable α in the step (4).

18. A driving control method of two or more all-solid-state batteries according to claim 1 as battery cells, comprising:
(1) primarily charging and discharging the two or more all-solid-state batteries to acquire reference voltages V_{0,a}, V_{0,b}, . . . and end voltages V_{end,a}, V_{end,b}, . . . of the two or more all-solid-state batteries;
(2) secondarily charging and discharging the two or more all-solid-state batteries under respective reference voltage conditions to acquire charge voltages V_{cut,a}, V_{cut,b}, . . . ;
(3) calculating difference values ΔVₐ, ΔV_{b}, . . . (ΔVₐ=|V_{cut,a}−V_{0,a}|, ΔV_{b}=|V_{cut,b}−V_{0,b}|, . . . ) between the charge voltages V_{cut,a}, V_{cut,b}, . . . and the reference voltages V_{0,a}, V_{0,b},
(4) comparing the difference values ΔVₐ, ΔV_{b}, . . . with the predetermined control variable α, and deriving values obtained by collectively subtracting the predetermined correction variable β from the end voltages V_{end,a}, V_{end,b}, . . . and setting the values as new end voltages V_{end′,a}, V_{end′,b}, . . . , when any one of the difference values ΔVₐ, ΔV_{b}, . . . is greater than or equal to the control variable α; and
(5) tertiarily charging and discharging the all-solid-state batteries based on the new end voltages V_{end′,a}, V_{end′,b}, . . . set in the step (4),
wherein the all-solid-state batteries are tertiarily charged and discharged under the reference voltage conditions in the step (2), when all of the difference values ΔVₐ, ΔV_{b}, . . . are less than the control variable α in the step (4).

19. A driving control method of two or more all-solid-state batteries according to claim 1 as battery cells, comprising:
(1) primarily charging and discharging the two or more all-solid-state batteries to acquire reference voltages V_{0,a}, V_{0,b}, . . . and end voltages V_{end,a}, V_{end,b}, . . . of the two or more all-solid-state batteries;
(2) secondarily charging and discharging the two or more all-solid-state batteries under respective reference voltage conditions to acquire charge voltages V_{cut,a}, V_{cut,b}, . . . ;
(3) calculating difference values ΔVₐ, ΔV_{b}, . . . (ΔVₐ=|V_{cut,a}−V_{0,a}|, ΔV_{b}=|V_{cut,b}−V_{0,b}|, . . . ) between the charge voltages V_{cut,a}, V_{cut,b}, . . . and the reference voltages V_{0,a}, V_{0,b}, . . . ;
(4) comparing the difference values ΔVₐ, ΔV_{b}, . . . with the predetermined control variable α, and deriving a value obtained by subtracting the predetermined correction variable B from the end voltage of a corresponding one of the all-solid-state batteries having the difference value greater than or equal the control variable α and setting the value as a new end voltage of the corresponding one of the all-solid-state battery, when any one of the difference values ΔVₐ, ΔV_{b}, . . . is greater than or equal to the control variable α; and
(5) tertiarily charging and discharging the corresponding one of the all-solid-state batteries based on the new end voltage set in the step (4),
wherein others of the all-solid-state batteries determined as having the difference values less than the control variable α in the step (4) are tertiarily charged and discharged under the reference voltage conditions in the step (2).

20. A vehicle comprising the all-solid-state battery of claim 1.
